(19) United States
(12) Patent Application Publication
(10) Pub. No.: US 2009/0307951 A1
(43) Pub. Date: Dec. 17, 2009

(54) EXTENDED CONTENT LABEL ARTICLE

(75) Inventor: Lee R. Lund, Hugo, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(73) Assignee: The Meyers Printing Companies, Ltd.

(21) Appl. No.: 12/481,787

(22) Filed: Jun. 10, 2009

Related U.S. Application Data
(60) Provisional application No. 61/060,854, filed on Jun. 12, 2008.

(51) Int. Cl. G09F 3/02; G09F 3/10

(52) U.S. Cl. 40/638; 40/672

(57) ABSTRACT

An extended content label article is generally provided. The article includes a back panel, a front panel having portions thereof releasably and reversibly united with the back panel, and an expandable plowfold interposed between non-united portions of the back panel and the front panel, and accessible upon release of a resealable portion of the portions of the front panel from the back panel. The front panel generally comprises a coupon, and advantageously includes a lamina united with the coupon. The expandable plowfold generally comprises a unitary sheet characterized by opposing surfaces, and a plurality of panels delimited by spaced apart creases. The plurality of panels includes a first end panel and a second end panel, a segment of the first end panel releasably attached to the back panel so as to be interiorly adjacent a portion of portions of the front panel releasably and reversibly united with the back panel.

This is a U.S. national patent application filed under 35 U.S.C. §111(a) claiming priority under 35 U.S.C. §119(e)(1) to U.S. provisional patent appl. Ser. No. 61/060,854, filed Jun. 12, 2008, said application incorporated herein by reference in its entirety.

### TECHNICAL FIELD

The present invention relates broadly to the field of product merchandising, namely, coupon promotions and the like. More particularly, the invention relates to extended content labels, more particularly still, to on-pack extended content labels comprising an instant redeemable coupon or the like.

### BACKGROUND OF THE INVENTION

In recent years it has been estimated that marketers offered up $386 billion in coupon savings to consumers. It has been estimated by the Promotion Marketing Association Coupon Counsel that over seventy-six percent of U.S. consumers use coupons.

Often cited reasons for using coupons include: to increase customer base; to increase product sales; to increase branding and awareness; to reward existing customers; to entice a return of former customers; and, to create an opportunity to up-sell a more profitable product. In addition to being an inexpensive form of marketing, coupons are a highly measurable form of marketing.

Numerous coupon delivery channels are available to reach consumers. More well known coupon distribution approaches include, but are not limited to, electronic delivery, free-standing inserts, instant redeemable, direct mail, shelf pad, and on-pack.

In connection to coupons, e.g., instant redeemable coupons (IRC), more particularly those “on-pack,” an advantageous variation permits the inclusion of additional content or an extended content. Broadly referred to as “extended content labels,” such articles have a variety of alternate monikers, such as, accordion booklet labels, winged booklets, and plowfold or plow-folded labels. Such multi-panel constructions are presently viewed as an essential part of a successful on-pack product marketing plan. Non-limiting, representative and advantageous uses comprise conveyance of usage ideas or hints, recipes, meal solutions, regulatory information, dosage details, cautions, instructional material, multi-lingual narratives, and/or information to build/fortify brand loyalty.

The objective of equipping merchandise and the like with an extended content label is hardly a recent development. Heretofore known articles abound, and appear varied in approach.

One approach for such labels or label articles is that characterized by a sheeting or other planar element, without a plowfold (i.e., an absence of a plowfold or booklet from the article). The teachings of Mortimer (Pub. No. U.S. 2003/0218330 A1), Whitehouse et al. (Pub. No. U.S. 2005/0275213 A1), Mangini et al. (U.S. Pat. No. 5,046,609), Hill (U.S. Pat. No. 5,866,181), and Voss (U.S. Pat. No. 6,670,009 B1) may be fairly characterized by such approach.

A further approach is that characterized by a foldable multi-panel article or booklet integral with, or part of, a package, the booklet being accessible upon “opening” a portion or subassembly of the package, i.e., the package or assembly is not resealable or reversibly closeable once “opened.” Representative teachings adopting this approach include Schneider (Pub. No. U.S. 2006/0065556 A1), Brown (U.S. Pat. No. 1,924,909), Tripodi (U.S. Pat. No. 3,695,422), Mack (U.S. Pat. No. 4,621,442), Pendry et al. (U.S. Pat. No. 6,329,034 B1) and Jones et al. (U.S. Pat. No. 6,432,500 B1).

A resealable extended content label, in the form of a label containing/dispensing package assembly is disclosed by Crum (U.S. Pat. No. 5,022,526), more particularly, a lid assembly characterized by an integral, expandable “folder” carrying labels for safe and secure dispensing therefrom is disclosed. Contextually, the assembly is advantageously carried by a bulk pharmaceutical bottle, discrete labels selectively removed from panels of the folder for affixation upon smaller patient bottles/containers.

Crum's package assembly may be fairly characterized by a foldable accordion-like leaflet or pamphlet which in turn comprises a stackable, complimentary hingeably connected array, set, and series of flexible panel members with intermediate inner panels and complimentary outer end flaps. A “first” inner flap, adjacent the top end flap or cover, is adhesively secured to a first segment of a base panel. The adjacent top end flap or cover is reversibly receivable upon a second or further segment of the base in furtherance of securing the remaining label bearing panels of the pamphlet in a nested arrangement upon the first inner flap. In it's capacity as a cover, the top end flap is integral to the assembly, more particular, hingedly linked to the balance of the sequentially extending flexible panel members. As should be readily appreciated, once the nested portion of the panels are accessed via manipulation of the cover panel thereof, the panels readily “spill-out,” one after another, from or with respect to the first inner flap.

In as much as extended content labels provide additional area to convey a message, a premium, information, etc., the relative surplus of material can prove problematic. For example, heretofore know articles combine a coupon with a booklet/plowfold in ways which result in the entire article being removed/disassociated from the merchandise, or, the coupon being removed from the article with the booklet/plowfold left behind in disarray; the mostly extended accordion like plowfold being left in an unattractive dangling state, one which often times necessitates removal of the merchandise from the shelf to the chagrin of, among others, the merchant.

To the extent that such shortcomings have been or are appreciated by others, it nonetheless remains advantageous to supply an extended content label that permits a synergy between the functionalities of a coupon and a booklet/plowfold article. Moreover, it remains desirable to provide, without limitation, an extended content label article wherein a coupon is provided for selective and ready disintegration relative to a booklet/plowfold subassembly/portion; a hybrid extended content label article wherein the booklet/plowfold retains an inherent integrity once the coupon is removed; and, an article which, having been manipulated by a consumer, may be readily returned or reconfigured to an aesthetically pleasing promotional article.

### SUMMARY OF THE INVENTION

An extended content label article is generally provided. The article includes a back panel, a front panel having portions thereof releasably and reversibly united with the back panel, and an expandable plowfold interposed between non-united portions of the back panel and the front panel, and accessible upon release of a resealable portion of the portions of the front panel from the back panel. The front panel generally comprises a coupon, and advantageously includes a lamina united with the coupon. The expandable plowfold generally comprises a unitary sheet characterized by opposing surfaces, and a plurality of panels delimited by spaced apart creases. The plurality of panels includes a first end panel and a second end panel, a segment of the first end panel releasably attached to the back panel so as to be interiorly adjacent a portion of portions of the front panel releasably and reversibly united with the back panel.

Advantageously, portions of the front panel releasably and reversibly united (e.g., joinable) with/to the back panel, are opposing portions, segments, strips, etc., such as left/right, upper/lower, diagonally opposed, laterally opposed, pairs. Furthermore, means are provided in relation to either the front panel portions, or corresponding portions (i.e., landings) of the rear panel, to permit the releasable and reversible union. Further still, the portion is preferably adapted to facilitate disengagement or disintegration of at least a portion of the portions, as by the inclusion of a line-of-weakness.

Although not necessary, the front panel desirably further includes a lamina overlaying the coupon, portions of the lamina (e.g., a transparent over laminate) extending beyond peripheral portions of the coupon. As noted above in connection to the front panel per se, features thereof may be associated with the lamina, more particularly, in connection to the portions (i.e., “wings”) extending beyond the coupon margins.

In connection to the expandable plowfold, a cover thereof generally comprises a panel immediately adjacent the first end panel of the expandable plowfold, more particularly, a rear surface of the immediately adjacent panel. Furthermore, the expandable plowfold is initially expanded via unfolding about a first crease delimiting the first end panel of the expandable plowfold. Further still, a portion of the panel of the plurality of panels of the expandable plowfold is reversibly secured to a portion of the first panel of the expandable plowfold in furtherance of maintaining an unexpanded condition for the expandable plowfold, more particularly, the panel reversibly secured to a portion of said first panel is spaced apart therefrom by an intermediate panel of the plurality of panels.

Advantageously, a first (e.g., interior) surface of the opposing surfaces of the plowfold includes a content density of printed material greater than that of a second (e.g., exterior) surface of said opposing surfaces. Either surface, but preferably the first surface of the opposing surfaces of the unitary sheet of the plowfold, in addition to the coupon, includes at least a single bar code. The first surface is revealed in its entirety subsequent to sequential unfolding of panels of the plurality of panels commencing from a crease delimiting the first end panel. More specific features and advantages obtained in view of those features will become apparent with reference to the drawing figures and DETAILED DESCRIPTION OF THE INVENTION.

### BRIEF DESCRIPTION OF THE DRAWINGS

FIG. 1 is a perspective view of a representative, non- limiting embodiment of the subject label article, elements thereof shown in states of partial release, with select surfaces selectively including printed matter, text, graphics, bar codes, etc., as delineated by phantom dashed lines therein, and throughout the figures;

FIG. 2 depicts the label article of FIG. 1 wherein a front panel has been partially disengaged or disintegrated from a back panel thereof, with an underlaying expandable plowfold revealed;

FIG. 3 depicts the label article of FIG. 2 wherein the underlaying expandable plowfold has been partially or initially expanded to reveal a plurality of panels thereof;

FIG. 4 depicts the label article of FIG. 3 wherein the underlaying expandable plowfold has been substantially expanded to reveal a first surface thereof; and,

FIG. 5 depicts the label article of FIG. 3 wherein the substantially expanded plowfold is hingedly relocated, left to right, to reveal a second surface thereof.

### DETAILED DESCRIPTION OF THE INVENTION & DRAWINGS

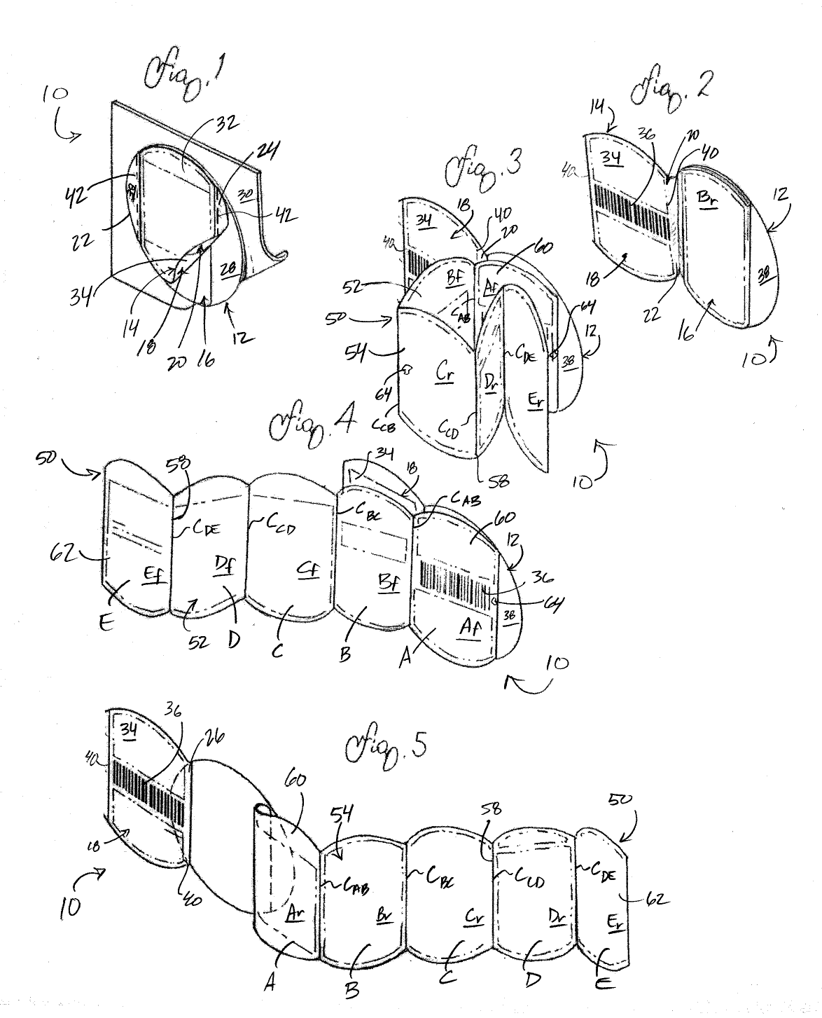

A representative, non-limiting embodiment of the subject extended content label article is generally show in FIGS. 1-5. The article of FIG. 1 is depicted having been manipulated in the remaining figures (i.e., FIGS. 2-5), namely, the article is depicted in a sequential, relative state or condition of “openness” or expansion as will be subsequently discussed. Moreover, it is to be understood that conventional means and materials are suited for/to the fabrication, production, etc. of the article as described and contemplated, and, with the familiarity of such means and materials known to persons of ordinary skill, the following description proceeds, namely, with a description of the extended content label article per se.

As a preliminary matter, it should be readily appreciated that terms such as left/right, up/down, front/back, top/bottom, over/under, etc., as may be periodically used throughout the instant description, or as may have been previously used, are primary intended to aid in an understanding and appreciation of the features of the subject extended content label article. Unless explicitly stated, such relational terms are not to be construed as limiting.

With general reference to the figures, and specific reference to FIGS. 1, 2 & 5, label article 10 generally includes a back panel or base 12, a front panel or cover 14, and an expandable plowfold 16 (FIGS. 1 & 2) interposed therebetween. The front panel 14, which generally comprises a coupon 18, more particularly, but not necessarily an instant redeemable coupon (IRC), and advantageously, but not necessarily, includes a lamina 20 overlaying the coupon 18. The front panel 14 generally includes portions releasably and reversibly united with the back panel, as by, for example, a pressure sensitive adhesive. The front panel portions are advantageously, but not necessarily, adapted, as by the inclusion of a line-of-weakness or the like, to facilitate disintegration of the front panel/coupon from the back panel as will be later discussed.

In as much as portions of the front panel are releasably and reversibly united with the back panel, opposing front panel portions (e.g., left/right portions as depicted in relation to FIGS. 1 & 2) are preferably, but not necessary, mated with corresponding portions of the back panel. More particularly, and without limitation, opposing peripheral segments thereof are preferably so united with the back panel, and more particularly still, opposing peripheral lateral portions 22, 24 of the front panel 14 are releasably united with opposing peripheral lateral portions 26, 28 of the back panel 12 as shown. Numerous suitable functional equivalents are known, available, and contemplated to selectively join or unite the front and back panels so as to permit access to the interior expandable plowfold via manipulation (e.g., swinging or hinging) of the front panel relative to the back panel, while nonetheless enabling a disintegration of the front panel in its entirety from the back panel as during, for example, coupon redemption at the time of check out or otherwise.

The expandable plowfold 16 is interposed between non-united portions of the front 14 and back 12 panels (see e.g., FIGS. 1 & 2), and is generally accessible (e.g., FIG. 2) upon release of a portion of the portions 22, 24 of the front panel 14 from the back panel 12 (FIG. 1). As shown in FIG. 1, it is intended that article 10 be initially supported upon a release liner 30 or the like prior to marketplace use, more particularly, the back panel 12 is reversibly united therewith in furtherance of disintegration of the article from the backing, compare FIG. 1 with FIG. 2, and subsequent affixation of the article to merchandise or the like via adhesion of the back panel to the merchandise (not shown). Plural articles are advantageously delivered, via the release liner, in sheet or roll form as is well known, for affixation to merchandise.

The coupon 18 of the front panel 14 generally includes opposing surfaces, e.g., a “front” or exterior surface 32 (e.g., FIG. 1), and a “back” or interior surface 34 (e.g., FIG. 2). Generally, and without intended limitation, the coupon surfaces 32, 34 bear printed matter, with at least one surface of the surface bearing a bar code 36 or the like (see e.g., FIG. 2).

To the extent that the front panel 14 includes a coupon over-lamina 20, as depicted, it is advantageous that the over-lamina 20 extend beyond peripheral portions of the coupon 18 (e.g., FIG. 1). In the context of the non-limiting FIG. 1 configurations for the front panel structures, “wings” 38 are delimited/defined by portions of the over-laminate 20 which extend beyond opposing lateral edges 40 of the coupon 18. The wings 38 provide a sufficient interface/contact area such that coupon 18 is supported or supportable upon base 12, more particularly, the coupon 18, via the wings 38 of the over-laminate 20, is reversibly affixed to the base 12 using, for example, a pressure sensitive adhesive or the like. Advantageously, the wings 38 include a line-of-weakness 24, perforation, or other known adaptation to facilitate removal of the front panel 14, or at least the portion thereof which includes the coupon 18.

It should be readily appreciated that boundless modifications to the aforementioned structure(s), even the omission and/or substitution of “wings” may be suitable to nonetheless effectuate reversible union of the coupon, via the front panel, to the back panel. Notionally, an extended content label article is provided which includes a readily disengageable coupon, a booklet/plowfold that is at least partially “housed” between plies of what is essentially a multi-ply extended content label article (FIG. 1), and/or a booklet/plowfold that itself is readily and selectively disengageable from an article base and/or united thereto so as to maintain an attractive appearance subsequent to the removal of the coupon.

Upon user manipulation of front panel 14 of article 10 of FIG. 1, as by peeling back a portion thereof so as to overcome adhesion of a wing of the wings 38 from the back panel 12, for example, a lower right portion of the wing to the viewer's right in connection to FIG. 1, and rotating or hinging the front panel 14 so as to reveal interior surface (i.e., back surface 34) thereof, the general configuration of FIG. 2 is achieved. With such manipulation, the underlaying booklet/plowfold 16 is revealed, with continued or further manipulation of the front panel 14, as indicated, resulting in a continued or further disintegration of the front panel 14 in relation to the back panel 12 in furtherance of complete disintegration of the front panel 14 from the back panel 12.

With particular reference now to FIGS. 3-5, a representative non-limiting plowfold is illustrated. The plowfold 16 comprises a discrete or unitary sheet of one or more plies (e.g., a single sheet 50 as illustrated) characterized by, among other things, front 52 and rear 54 surfaces, and a plurality of panels 56 delimited by spaced apart creases 58. While not intended as limiting, but instead illustrative, panels of the contemplated expandable plowfold number from about three to twelve, or more, with five (5) illustrated in the figures. To facilitate the remainder of this discussion, panels 56 are designated A-E as indicated, with front and rear surface thereof designated by a subscript “f” or “r” as the circumstance warrants (e.g., see FIG. 2, wherein panel surfaces “B_{f}” and “Cᵣ” are indicated for adjacent panels B & C of plowfold 16). Moreover creases 58 delimiting adjacent panels are designated “C” with subscripts denoting a shared boundary, e.g., C_{AB} is a crease common to panels A & B.

The plurality of panels 56 generally include a first end panel 60 and a second end panel 62 (e.g., panels A & E respectively, as shown), a segment of the first end panel 60 releasably attached to the back panel 12 so as to be interiorly adjacent a portion of portions 22, 24 of the front panel 14 releasably and reversibly united with the back panel 12. Rear surface of panel A (i.e., Aᵣ), as best seen with reference to FIG. 5, is adhesively or otherwise affixed to the back panel 12 so as to be readily releasable therefrom. More particularly, as shown, panel A is releasably united with the back panel 12 along a lateral edge segment 28 thereof, preferably, but not necessarily, via a pressure sensitive adhesive or the like.

With reference now to FIGS. 2 & 3, a “cover” of the plowfold 16 (i.e., the visible surface of the expandable plowfold of FIG. 2) advantageously, but not necessarily, comprises a surface of the panel immediately adjacent the first end panel 60 (i.e., a surface of panel B which is immediately adjacent panel A as shown), more particularly, rear surface Bᵣ of panel B. In this context, a preferred, non-limiting, predetermined folding/pagination sequence defining the expandable plowfold 16 of FIG. 2 is appreciated with reference to FIG. 4, and is generally as follows: panel E is folded about crease C_{DE} such that Eᵣ overlies Dᵣ; thereafter, consolidated panels E & D are folded about C_{CD} such that D_{f} overlies C_{f}; thereafter, consolidated panels E-C are folded about C_{BC} such that E_{f} overlies B_{f}; and, thereafter, consolidated panels E-B are folded about C_{AB} such that Cᵣ overlies A_{f}. Moreover, it should be readily appreciated that the expandable plowfold 16 is initially expanded via unfolding about a first crease delimiting the first end panel 60 of the expandable plowfold 16, namely, the crease separating the first end panel 60 from its immediately adjacent panel (e.g., as shown, crease C_{AB} delimiting panels A & B, more particularly, unfolding to reveal A_{f} and B_{f}). In connection to maintaining a unexpanded condition or status of/for the expandable plowfold, advantageously, but not necessarily, an adhesive “dot” or the like may be interposed between the first end panel 60 and the panel of the plurality of panels 56 of the plowfold 16 overlying/intending to overlie same, e.g., panel A & C, more particularly, as shown, either panel surface A_{f} & Cᵣ may include means 64 to releasably unite panels A & C.

In as much a preferred embodiment, including select departures with regard to one or more features, elements, and/or interrelationships with regard thereto, has been disclosed, there are nonetheless other variations of the subject extended content label article, some of which are or will become obvious to those skilled in the art. It is to be understood that this disclosure, in many respects, is only illustrative. Changes may be made in details, particularly in matters of shape, size, material, and arrangement of parts, as the case may be, without exceeding the scope of the invention, and liberal equivalents thereof, as delimited by the claims appended hereto.

That which is claimed is:

1. A label article comprising:
a. a back panel;
b. a front panel comprising a coupon, portions of said front panel releasably and reversibly united with said back panel; and,
c. an expandable plowfold interposed between non-united portions of said back panel and said front panel and accessible upon release of a resealable portion of said portions of said front panel from said back panel, said expandable plowfold comprising a unitary sheet characterized by opposing surfaces and a plurality of panels delimited by spaced apart creases, said plurality of panels including a first end panel and a second end panel, a segment of said first end panel releasably attached to said back panel so as to be interiorly adjacent a portion of portions of said front panel releasably and reversibly united with said back panel.

2. The label article of claim 1 wherein portions of said front panel releasably and reversibly united with said back panel comprise peripheral segments thereof.

3. The label article of claim 1 wherein opposing portions of said front panel are releasably and reversibly united with said back panel.

4. The label article of claim 1 wherein opposing portions of said front panel are releasably and reversibly united with opposing portions of said back panel.

5. The label article of claim 1 wherein opposing peripheral lateral portions of said front panel are releasably and reversibly united with said back panel.

6. The label article of claim 1 wherein opposing peripheral lateral portions of said front panel are releasably and reversibly united with opposing peripheral lateral portions of said back panel.

7. The label article of claim 1 wherein said portions of said front panel releasably and reversibly united with said back panel include a coating of pressure sensitive adhesive.

8. The label article of claim 1 wherein a portion of said portions of said front panel releasably and reversibly united with said back panel include a line-of-weakness.

9. The label article of claim 1 wherein said front panel further comprises a lamina, said lamina overlaying said coupon.

10. The label article of claim 1 wherein said front panel further comprises a lamina overlaying said coupon, portions of said lamina extending beyond peripheral portions of said coupon.

11. The label article of claim 10 wherein said portions of said lamina extending beyond peripheral portions of said coupon are releasably and reversibly united with said back panel.

12. The label article of claim 10 wherein said portions of said lamina extending beyond peripheral portions of said coupon comprise opposing peripheral lamina segments.

13. The label article of claim 12 wherein said opposing peripheral lamina segments include a coating of pressure sensitive adhesive.

14. The label article of claim 11 wherein a portion of said portions of said lamina extending beyond peripheral portions of said coupon include a line-of-weakness in furtherance of disintegration of said front panel from said back panel.

15. The label article of claim 1 wherein a cover of said expandable plowfold comprises a panel immediately adjacent said first end panel of said expandable plowfold.

16. The label article of claim 1 wherein a cover of said expandable plowfold comprises a rear surface of a panel immediately adjacent said first end panel of said expandable plowfold.

17. The label article of claim 1 wherein said expandable plowfold is initially expanded via unfolding about a first crease delimiting said first panel of said expandable plowfold.

18. The label article of claim 1 wherein a portion of a panel of said plurality of panels of said expandable plowfold is reversibly secured to a portion of said first panel of said expandable plowfold in furtherance of maintaining an unexpanded condition for said expandable plowfold.

19. The label article of claim 18 wherein said panel of said plurality of panels of said expandable plowfold reversibly secured to a portion of said first panel is spaced apart therefrom by an intermediate panel of said plurality of panels.

20. The label article of claim 1 wherein each surface of said opposing surfaces of said unitary sheet bears printed material.

21. The label article of claim 20 wherein a first surface of said opposing surfaces includes a content density of printed material greater than that of a second surface of said opposing surfaces.

22. The label article of claim 21 wherein said first surface is revealed in its entirety subsequent to sequential unfolding of panels of said plurality of panels commencing from a crease delimiting said first end panel.

23. The label article of claim 1 wherein said coupon and a panel of said plurality of panels include a bar code.

24. The label article of claim 1 wherein said panels of said expandable plowfold number from about three to twelve.

25. The label article of claim 1 wherein said coupon comprises an instant redeemable coupon.

26. The label article of claim 1 in combination with a release liner, said back panel united therewith.

27. The label article of claim 1 in combination with merchandise, said back panel united therewith.

28. The label article of claim 1 provided in a sheet format.

29. The label article of claim 1 provided in roll format.
